(19) United States
(12) Patent Application Publication
(10) Pub. No.: US 2019/0095828 A1
(43) Pub. Date: Mar. 28, 2019

(54) AUTOMATIC RAMP-UP OF CONTROLLED EXPERIMENTS

(71) Applicant: LinkedIn Corporation, Sunnyvale, CA (US)

(72) Inventors: Ya Xu, Los Altos, CA (US); Weitao Duan, Mountain View, CA (US); Shaochen Huang, San Francisco, CA (US); Mingyue Tan, Burlingame, CA (US); Shaohua Xie, Santa Clara, CA (US)

(73) Assignee: LinkedIn Corporation, Sunnyvale, CA (US)

(21) Appl. No.: 15/717,719

(22) Filed: Sep. 27, 2017

(51) Int. Cl. G06Q 10/06; G06Q 30/02

(52) U.S. Cl. CPC G06Q 10/0635; G06Q 30/0243; G06Q 30/0201

(57) ABSTRACT

The disclosed embodiments provide a system for managing an A/B test. During operation, the system calculates a first risk associated with ramping up exposure to a first A/B test by a first ramp amount. Next, the system uses a first sequential hypothesis test to compare the first risk with a first risk tolerance for the first A/B test. When the first sequential hypothesis test indicates that the first risk is within the first risk tolerance, the system automatically triggers a ramp-up of exposure to the first A/B test by the first ramp amount.

### BACKGROUND

### Field

The disclosed embodiments relate to A/B testing. More specifically, the disclosed embodiments relate to techniques for performing automatic ramp-up of controlled experiments.

### Related Art

A/B testing, or controlled experimentation, is a standard way to evaluate user engagement or satisfaction with a new service, feature, or product. For example, a social networking service may use an A/B test to show two versions of a web page, email, offer, article, social media post, advertisement, layout, design, and/or other information or content to randomly selected sets of users to determine if one version has a higher conversion rate than the other. If results from the A/B test show that a new treatment version performs better than an old control version by a certain amount, the test results may be considered statistically significant, and the new version may be used in subsequent communications with users already exposed to the treatment version and/or additional users.

Most A/B tests undergo a manual “ramp up” process, in which exposure to a treatment version is restricted to a small percentage of users and gradually increased as metrics related to the performance of the treatment version are collected. Such ramping up may be performed to control risks associated with launching new features, such as negative user experiences and/or revenue loss. On the other hand, the speed of the ramp-up process may interfere with the pace and cost of innovation. In particular, a ramp-up process that is too slow may consume additional time and resources, and a ramp-up process that is too fast may result in suboptimal decision-making and/or exposure to risks associated with new feature launches. Consequently, controlled experimentation may be improved by balancing speed and decision quality during ramping up of A/B tests.

### BRIEF DESCRIPTION OF THE FIGURES

FIG. 1 shows a schematic of a system in accordance with the disclosed embodiments.

FIG. 2 shows a system for ramping up an A/B test in accordance with the disclosed embodiments.

FIG. 3 shows a flowchart illustrating a process of ramping up an A/B test in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

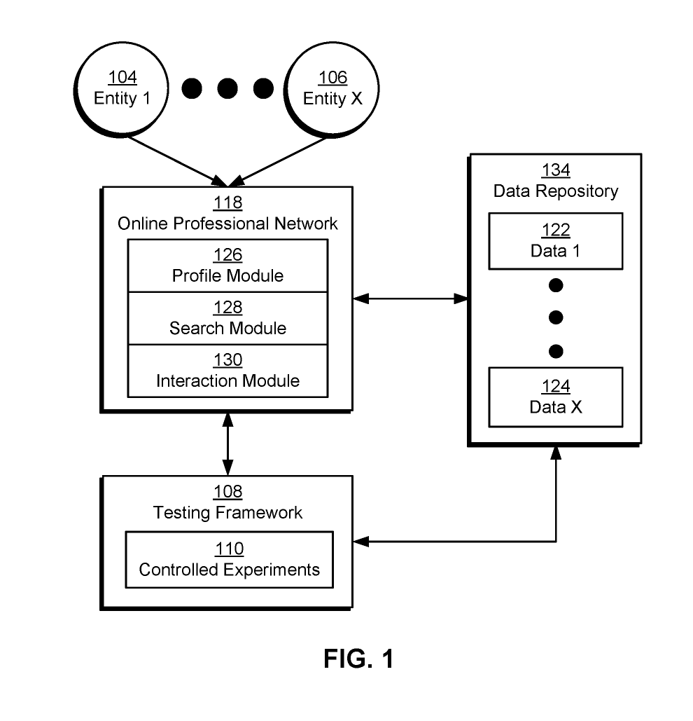

The disclosed embodiments provide a method and system for performing A/B testing. More specifically, the disclosed embodiments provide a method and system for performing automatic ramping of controlled experiments such as A/B tests. As shown in FIG. 1, a social network may include an online professional network 118 that is used by a set of entities (e.g., entity 1 104, entity x 106) to interact with one another in a professional and/or business context.

The entities may include users that use online professional network 118 to establish and maintain professional connections, list work and community experience, endorse and/or recommend one another, search and apply for jobs, and/or perform other actions. The entities may also include companies, employers, and/or recruiters that use online professional network 118 to list jobs, search for potential candidates, provide business-related updates to users, advertise, and/or take other action.

The entities may use a profile module 126 in online professional network 118 to create and edit profiles containing profile pictures, along with information related to the entities' professional and/or industry backgrounds, experiences, summaries, projects, and/or skills. Profile module 126 may also allow the entities to view the profiles of other entities in the online professional network.

Next, the entities may use a search module 128 to search online professional network 118 for people, companies, jobs, and/or other job- or business-related information. For example, the entities may input one or more keywords into a search bar to find profiles, job postings, articles, and/or other information that includes and/or otherwise matches the keyword(s). The entities may additionally use an “Advanced Search” feature on online professional network 118 to search for profiles, jobs, and/or information by categories such as first name, last name, title, company, school, location, interests, relationship, industry, groups, salary, and/or experience level.

The entities may also use an interaction module 130 to interact with other entities on online professional network 118. For example, interaction module 130 may allow an entity to add other entities as connections, follow other entities, send and receive messages with other entities, join groups, and/or interact with (e.g., create, share, re-share, like, and/or comment on) posts from other entities. Interaction module 130 may also allow the entity to upload and/or link an address book or contact list to facilitate connections, follows, messaging, and/or other types of interactions with the entity's external contacts.

Those skilled in the art will appreciate that online professional network 118 may include other components and/or modules. For example, online professional network 118 may include a homepage, landing page, and/or newsfeed that provides the latest postings, articles, and/or updates from the entities' connections and/or groups to the entities. Similarly, online professional network 118 may include mechanisms for recommending connections, job postings, articles, and/or groups to the entities.

In one or more embodiments, data (e.g., data 1 122, data x 124) related to the entities' profiles and activities on online professional network 118 is aggregated into a data repository 134 for subsequent retrieval and use. For example, records of profile updates, profile views, connections, endorsements, invitations, follows, posts, comments, likes, shares, searches, clicks, messages, interactions with a group, address book interactions, responses to a recommendation, purchases, and/or other actions performed by an entity in the online professional network may be tracked and stored in a database, data warehouse, cloud storage, and/or other data-storage mechanism providing data repository 134.

In turn, data in data repository 134 may be used by a testing framework 108 to conducted controlled experiments 110 of features in online professional network 118. Controlled experiments 110 may include A/B tests that expose a subset of the entities to a treatment version of a message, feature, and/or content. For example, testing framework 108 may select a random percentage of users for exposure to a new treatment version of an email, social media post, feature, offer, user flow, article, advertisement, layout, design, and/or other content during an A/B test. Other users in online professional network 118 may be exposed to an older control version of the content.

During an A/B test, entities affected by the A/B test may be exposed to the treatment or control versions, and the entities' responses to or interactions with the exposed versions may be monitored. For example, entities in the treatment group may be shown the treatment version of a feature after logging into online professional network 118, and entities in the control group may be shown the control version of the feature after logging into online professional network 118. Responses to the control or treatment versions may be collected as clicks, conversions, purchases, comments, new connections, likes, shares, and/or other metrics representing implicit or explicit feedback from the entities. The metrics may be aggregated into data repository 134 and/or another data-storage mechanism on a real-time or near-real-time basis and used by testing framework 108 to compare the performance of the treatment and control versions.

Testing framework 108 may also use the assessed performance of the treatment and control versions to guide ramping up of the A/B test. During such ramping up, exposure to the treatment version may be gradually increased as long as the collected metrics indicate that the treatment version is performing well, relative to the control version. On the other hand, ramping up of A/B tests may be associated with a tradeoff between speed, decision-making quality, and risk. For example, a ramp-up process that is too slow may consume additional time and resources, while a ramp-up process that is too fast may result in suboptimal decision-making and exposure to risks related to negative performance of the treatment version.

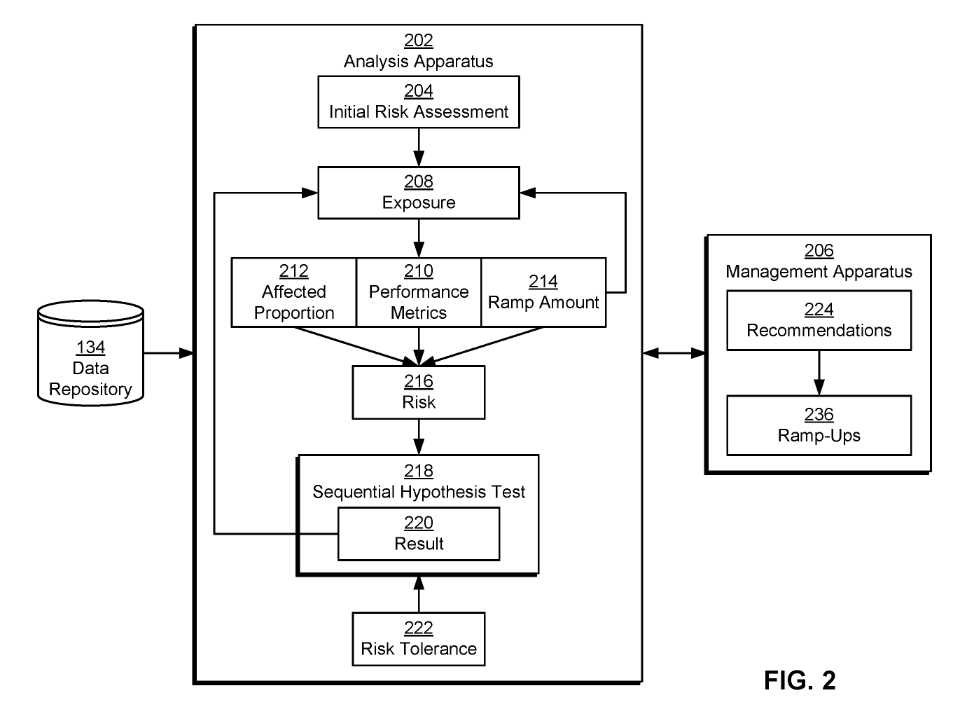

In one or more embodiments, testing framework 108 includes functionality to perform automatic ramping of online controlled experiments 110 in a way that balances speed, decision-making quality, and risk associated with conducting controlled experiments 110. As shown in FIG. 2, a system for ramping up an A/B test (e.g., testing framework 108 of FIG. 1) may include an analysis apparatus 202 and a management apparatus 206. Each of these components is described in further detail below.

Analysis apparatus 202 may compare a risk 216 associated with ramping up of the A/B test by a given ramp amount 214 with a risk tolerance 222 for the A/B test. Risk 216 may represent a positive or negative impact of the A/B test on revenue, user experience, and/or other attributes associated with use of the tested product or feature. For example, risk 216 may be a metric that measures the difference in click-through rate (CTR) between treatment and control variants of a page, advertisement, feature, content item, message, and/or email. Risk 216 may also, or instead, account for factors such as the number or proportion of users affected by the A/B test and/or ramp amount 214 (e.g., the percentage of users affected by ramping up of the A/B test).

First, analysis apparatus 202 may obtain an initial risk assessment 204 for the A/B test. Initial risk assessment 204 may represent an estimate of risk 216 associated with exposure to a treatment version in the A/B test before the A/B test is conducted. For example, an experimenter associated with the A/B test may specify initial risk assessment 204 as “zero,” “low,” “medium,” “high,” and/or another risk category. In another example, the experimenter may provide a numeric score representing initial risk assessment 204, with a higher score indicating higher estimated risk and a lower score indicating lower estimated risk. In a third example, the experimenter may input one or more attributes of the A/B test (e.g., features affected by the A/B test, an affected proportion 212 of users, etc.) into a module, and the module may generate a risk category, risk score, and/or another representation of initial risk assessment 204 based on the inputted attributes.

Next, analysis apparatus 202 may determine an initial exposure 208 to the A/B test based on initial risk assessment 204. For example, the initial exposure 208 may represent a percentage or proportion of users and/or entities exposed to the treatment version at the start of the A/B test. The initial exposure 208 may be obtained from a ramp-up plan that is tailored to initial risk assessment 204. For example, a lower estimated risk in initial risk assessment 204 may be matched to a more aggressive ramp-up plan that allocates a higher initial exposure 208 and larger subsequent ramp amounts (e.g., ramp amount 214) to the treatment version. Conversely, a higher estimated risk in initial risk assessment 204 may be matched to a more conservative ramp-up plan that assigns a lower initial exposure 208 and smaller subsequent ramp amounts to the treatment version. In another example, an experimenter and/or administrator associated with the A/B test may specify, with or without initial risk assessment 204, a custom ramp-up plan that includes the first exposure 208 to the treatment version, as well as additional ramp amounts used to subsequently increase exposure 208 to the treatment version.

After exposure 208 to the treatment version is initiated, analysis apparatus 202 and/or another component of the system may collect performance metrics 210 related to both the treatment and control versions of the A/B test. For example, the component may obtain performance metrics 210 as rates and/or numbers of clicks, conversions, purchases, comments, new connections, likes, shares, and/or other measurements of user feedback after exposure to the treatment or control version. Performance metrics 210 may be obtained from data repository 134 and/or in real-time or near-real-time (e.g., as records of the user feedback are generated or received).

Analysis apparatus 202 may use performance metrics 210 and a number of other attributes to calculate a measure of risk 216 of ramping up exposure to the treatment version by a subsequent ramp amount 214. The attributes may include an affected proportion 212 that represents the proportion or percentage of users or entities that are affected by the A/B test. For example, affected proportion 212 for an A/B test that compares features within an older version of a mobile application may represent the proportion of all users of the mobile application that use the older version. In another example, affected proportion 212 for an A/B test that compares variations on an address book import feature of a social network (e.g., online professional network 118 of FIG. 1) is likely to be smaller than affected proportion 212 for an A/B test that compares variations on a home page of the social network.

Analysis apparatus 202 may also use ramp amount 214 as an attribute for calculating risk 216. Ramp amount 214 may be expressed as a proportional increase in exposure to the treatment version of the A/B test. For example, a 5% ramp amount 214 may indicate additional exposure 208 to the treatment version for 5% of all users in affected proportion 212. Thus, a larger ramp amount 214 may increase risk 216 associated with exposure to a treatment version that can have a negative impact on user experiences and/or revenue.

Next, analysis apparatus 202 may compare the calculated risk 216 associated with ramping up the A/B test by a given ramp amount 214 with a risk tolerance 222 for the A/B test. Risk tolerance 222 may represent a predefined threshold for risk 216 that varies based on performance metrics 210 and/or business requirements. For example, risk tolerance 222 may be set by an owner and/or administrator of performance metrics 210, an experimenter associated with the A/B test, and/or another user that manages the use of features affected by the A/B test. If risk 216 does not exceed risk tolerance 222, ramp-up of the A/B test by ramp amount 214 can proceed. If risk 216 exceeds risk tolerance 222, ramp-up of the A/B test by ramp amount 214 may be deemed too risky and averted.

For example, risk 216 may be calculated or defined using the following:

$$R ( q ) = \vert δ \vert * g ( r ) * h ( q )$$

$$δ = \frac{treatment mean - control mean}{control mean}$$

$$g ( r ) = \{ \begin{matrix}r , & r \geq {r}_{0} \\ {r}_{0} , & r < {r}_{0}\end{matrix} , \\ h ( q ) = \{ \begin{matrix}q , & q \geq {q}_{0} \\ {q}_{0} , & q < {q}_{0}\end{matrix}$$

In the above equations, δ measures the difference in performance metrics 210 between the treatment and control versions of the A/B test on users or entities in affected proportion 212, g(r) represents a value of affected proportion 212 r that is truncated at r₀, and h(q) represents a value of ramp amount 214 q that is truncated at q₀. Consequently, risk 216 may be higher for a higher affected proportion 212 of users or entities and/or a larger ramp amount 214. Moreover, truncated versions of affected proportion 212 and ramp amount 214 may be used to produce a value of risk 216 that better reflects a bad experiment (i.e., large δ) and can be used to discontinue the experiment and/or ramping of the experiment.

In turn, comparison of risk 216 and risk tolerance 222 may be expressed using the following:

R(q)≤τ

The above expression may indicate that risk 216 (i.e., R(q)) associated with ramping up the A/B test by ramp amount 214 q is “tolerable” if the value of risk 216 is below a threshold risk tolerance 222 represented by τ.

As shown in FIG. 2, analysis apparatus 202 may use a sequential hypothesis test 218 to compare risk 216 with risk tolerance 222. For example, analysis apparatus 202 may use a generalized sequential probability ratio test (GSPRT) to compare risk 216 with risk tolerance 222 as performance metrics 210 and/or other data used to update risk 216 are received. While sequential hypothesis test 218 is conducted, a result 220 of sequential hypothesis test 218 may be periodically and/or continually evaluated to determine if risk 216 is above or within risk tolerance 222.

Continuing with the exemplary equations above, Q={q₁, q₂, q₃, q₄, . . . } may represent an ordered set of possible ramp-ups 236, with each value in the set specifying a percentage ramp amount 214 by which the A/B test is to be ramped up. For example, the ordered set may include the following percentages:

Q={1%, 5%, 10%, 25%, 50%}

As mentioned above, the first ramp amount 214 may be determined based on initial risk assessment 204, with a higher initial risk resulting in a lower first ramp.

Data from the first and/or subsequent ramp-ups may then be used to compare risk 216 with risk tolerance 222 and determine if risk 216 is low enough to continue ramping to the next ramp amount 214. For a potential next ramp amount 214 q E Q, sequential hypothesis test 218 may include the following hypotheses:

H₀^{q}:R(q)≤τ

H₁^{q}: R(q)>τ

The risk function R(q) may monotonically increase with q. Thus, for any q₁<q₂, if H₀^{q}^{₂} is accepted, H₀^{q}^{₁} is also accepted. In turn, the system may utilize a greedy approach by selecting the maximum ramp amount 214 that still produces a level of risk 216 that is within risk tolerance 222. After a ramp-up of the A/B test to the identified ramp amount 214 is performed, sequential hypothesis test 218 may be repeated to continue ramping up of the A/B test until the A/B test is stopped or ramp-up of the A/B test is complete.

A GSPRT that tests the above hypotheses at time t may have the following test statistic for Hₖ^{q}:

$${L}_{t} ( {H}_{k}^{q} ) = \frac{{sup}_{{H}_{k}^{q}} {π}_{k} {f}_{k}^{t} ( {X}^{t} )}{{\sum }_{j = 0}^{1} {sup}_{{u}_{j}^{q}} {π}_{j} {f}_{j}^{t} ( {X}^{t} )} , k = 0 , 1$$

In the above test statistic, ƒₖ^{t} represents a likelihood function for independent samples of a performance metric X^{t}=(X₁^{t},X₂^{t}, . . . ) up to time t, and πₖ represents the prior probability for hypothesis Hₖ^{q}.

The hypothesis Hₖ^{q} may be accepted if:

$${L}_{t} ( {H}_{k}^{q} ) > \frac{1}{1 + {A}_{k}}$$

In the above expression, Aₖ may be chosen to control for type I and type II errors associated with accepting Hₖ^{q} incorrectly. Moreover, the posterior probabilities may sum to 1:

Lₜ(H₀^{q})+Lₜ(H₁^{q})=1

As a result, restricting 0<Aₖ<1 may ensure that at most one hypothesis Hₖ (where k=1, 2) is accepted.

In turn, the test statistic Lₜ(H₀^{q}) may fall into three regions: an acceptance region, a monitoring region, and a rejection region. A threshold between the acceptance region and the monitoring region may be denoted by 1/(1+A₀), and a threshold between the monitoring region and the rejection region may be denoted by A₁(1+A₁). An equivalent set of regions may be constructed for the test statistic Lₜ(H₁^{q}), with thresholds between the regions represented by A₀/(1+A₀) and 1/(1+A₁).

If the test statistic falls into the rejection region, risk 216 may be considered too high (i.e., higher than risk tolerance 222) to ramp up the A/B test by ramp amount 214. If the test statistic falls into the acceptance region, risk 216 may be considered low enough (i.e., within risk tolerance 222) to ramp up the A/B test by ramp amount 214. If the test statistic is in between the acceptance and rejection regions, statistical hypothesis test 218 may lack sufficient data to support either hypothesis. As a result, statistical hypothesis test 218 may continue running to evaluate risk 216 and risk tolerance 222 based on additional data.

The explicit form of likelihood function ƒₖ^{t} may be unknown and/or vary across different performance metrics 210. For sample sizes that are large, the multivariate Central Limit Theorem may indicate that the likelihood function of the relative difference of the sample means approaches a normal distribution. The test statistic may thus be converted into the following version:

$${L}_{t} ( {H}_{k}^{q} ) = \frac{{sup}_{{H}_{k}^{q}} {π}_{k} exp ( - \frac{{( Δ - δ )}^{2}}{{s}^{2}} )}{{\sum }_{j = 0}^{1} {sup}_{{u}_{j}^{q}} {π}_{j} exp ( - \frac{{( Δ - δ )}^{2}}{{s}^{2}} )}$$

In the above expression, 66 may represent the likelihood function of the relative difference of the sample means; s² may represent the variance of Δ, which may be estimated from the data; and δ may be the parameter from the risk function that measures the relative difference in performance metrics 210 between the treatment and control versions. For readability, the time parameter t may be omitted from some notations.

As mentioned above, Aₖ may be chosen to control for type I and type II errors associated with the hypotheses of sequential hypothesis test 218. For example, a₀ may represent the probability that H₀ is accepted when H₁ is true, and a₁ may represent the probability that H₁ is accepted when H₀ is true. In other words, a₀ may represent a type II error, while a₁ may represent a type I error. Assuming H₁ is true, H₀ is less likely to be accepted incorrectly with a smaller A₀ (and thus a bigger 1/(1+A₀)). In general, errors a₀ and a₁ may be bounded by the choices of A₀ and A₁ (i.e., a₀≤Aₖ for k=0, 1).

Moreover, type I and type II errors may represent a tradeoff between speed and risk. When a type I error is made, ramping up of the A/B test is omitted when risk 216 is within risk tolerance 222, resulting in unnecessary delay in ramping up of the A/B test. When a type II error is made, a ramp-up of the A/B test is performed when risk 216 is higher than risk tolerance 222, resulting in a higher-than-anticipated level of risk in the ramp-up. In turn, the values of A₀ and A₁ may be selected to balance the tradeoff between speed and risk. For example, A₀ may be selected to be higher than A₁ when infrastructure to identify bad experiments is in place and speed is preferred. Conversely, A₁ may be selected to be higher than A₀ when lower risk 216 is preferred to a faster ramp-up of the A/B test.

Once result 220 is statistically significant and/or otherwise conclusive, sequential hypothesis test 218 may be stopped, and analysis apparatus 202 may output result 220. In turn, management apparatus 206 may generate recommendations 224 related to ramping of the A/B test and/or perform automatic ramp-ups 236 of the A/B test based on result 220.

For example, result 220 of the GSPRT described above may be assessed periodically (e.g., daily) and/or continually by comparing the two test statistics to the corresponding thresholds. If Lₜ(H₁^{q})>1/(1+A₁) for every possible q∈Q, H₁ is accepted as result 220. In turn, management apparatus 206 may output a notification that recommends discontinuing ramping up of the A/B test, ramping down the A/B test to a lower level of exposure 208, and/or terminating the A/B test. Management apparatus 206 may also, or instead, carry out the recommended action by, for example, stopping the A/B test and/or configuring the A/B test to stop exposing additional users or entities to the treatment version.

If Lₜ(H₀^{q})>1/(1+A₀) for some q∈Q, H₀ is accepted as result 220, and exposure 208 to the treatment version is ramped up to the largest value of q for which risk 216 remains within risk tolerance 222 (e.g., the largest q for which the above inequality holds). Management apparatus 206 may then output a notification that recommends ramping up of exposure 208 to the treatment version by ramp amount 214 q. Management apparatus 206 may also, or instead, execute the ramp-up to the identified ramp amount 214 by selecting a subset of users or entities for exposure 208 to the treatment version during the ramp-up and/or displaying or otherwise exposing the treatment version to the selected users or entities.

If neither test statistic is conclusive, the current exposure 208 to the treatment version is maintained until the next evaluation of the GSPRT (e.g., the next day). If the GSPRT is still inconclusive at the end of a predefined period (e.g., a week), risk 216 may be assumed to be within risk tolerance 222, and H₀ is implicitly accepted as result 220. Management apparatus 206 may then output a recommendation to ramp-up to the next ramp amount 214 and/or carry out an automatic ramp-up of the A/B test to ramp amount 214.

Those skilled in the art will appreciate that the A/B test may include multiple performance metrics 210 with different risk tolerances, levels of importance, and/or prior risks. For example, an A/B test may track the performance of two different versions of a page or feature using multiple performance metrics 210 that include page views, CTRs, conversion rates, and/or user sessions. As a result, the comparison of risk 216 and risk tolerance 222 using sequential hypothesis test 218 may be adapted to multiple performance metrics 210 to produce a single result 220 representing a decision to ramp up or not ramp up the A/B test.

Continuing with the exemplary GSPRT described above, Lₜ⁽¹⁾(H₁^{q}), . . . , Lₜ^{(M)}(Hₖ^{q}) may represent the test statistic Lₜ(H₁^{q}) for multiple performance metrics 210 sorted in descending order of importance or impact, and M may represent the total number of performance metrics 210. Instead of comparing against a fixed threshold of 1/(1+A₁), acceptance of hypothesis H₁ may use the following comparison:

$${L}_{t}^{( m )} ( {H}_{1}^{q} ) > \frac{1}{1 + \frac{{mA}_{1}}{M}}$$

When the comparison holds true for at least one metric m=1, . . . , M, H₁ may be accepted, and ramping up of the A/B test may be discontinued. On the other hand, an increase in false negatives may be mitigated by ramping up the A/B test by a given ramp amount 214 q when H₁ is not accepted for any performance metric and H₀ is accepted for the majority (e.g., 80%) of performance metrics 210.

Ramping up of the A/B test may proceed by using sequential hypothesis test 218 to compare risk 216 with risk tolerance 222 until exposure 208 to the treatment version reaches a limit representing a maximum performance assessment for the A/B test. For example, an A/B test with one treatment version, one control version, and a 100% affected proportion 212 of users may have a 50% maximum performance assessment limit because exposure 208 of half the users to the treatment version may allow all performance metrics 210 from the treatment version to be compared with all performance metrics 210 from the control version. In another example, an A/B test with one treatment version, one control version, and a 20% affected proportion 212 of users may have a maximum performance assessment limit of 10% because the most precise measurement of performance is made by dividing exposure 208 to the treatment and control versions between two groups of the same size within the 20% of users affected by the A/B test.

After the maximum performance assessment limit is reached, the A/B test may be conducted at the limit over a predefined period (e.g., one week) to improve the precision of the A/B test and account for time-based factors such as changes in user interaction with a new feature over time and/or performance metrics 214 that are biased toward heavy users of a feature. If any performance metrics 214 indicate negative performance of the treatment version beyond a significance level that is based on the p-values of performance metrics 214 and/or the number of performance metrics 214, ramping up beyond the limit may be averted.

If performance metrics 214 for the treatment version are not negative beyond the corresponding significance levels, continued ramping up of exposure 208 to the treatment version beyond the limit may be performed based on operational risks associated with the ramp-up. For example, exposure 208 to the treatment version beyond a 50% limit may be increased using one or more optional ramp-ups 236 to ensure that services and/or endpoints affected by the treatment version can handle increased load from the ramp-ups. Additional ramp-ups beyond the limit may also, or instead, be performed to collect and compare additional performance metrics 210 over a longer period. For example, exposure 208 to the treatment version may be ramped up to 95% of all users in affected proportion 212 to determine if the A/B test result measured while exposure 208 is at the maximum performance assessment limit is sustainable.

By automating ramp-ups 236 of A/B tests based on measures of risk 216 and corresponding values of risk tolerance 222 for the A/B tests, the system of FIG. 2 may expedite ramping up of the A/B tests without exceeding tolerable levels of risk 216 for the A/B tests. The system may further reduce overhead associated with conventional techniques that manually ramp up A/B tests after analyzing multiple performance metrics 210 and/or accounting for experiment durations. Consequently, the system may improve the speed, precision, and scalability of online A/B testing and/or technical innovation that is propagated and/or verified through online A/B testing.

Those skilled in the art will appreciate that the system of FIG. 2 may be implemented in a variety of ways. First, analysis apparatus 202, management apparatus 206, and/or data repository 134 may be provided by a single physical machine, multiple computer systems, one or more virtual machines, a grid, one or more databases, one or more filesystems, and/or a cloud computing system. Analysis apparatus 202 and management apparatus 206 may additionally be implemented together and/or separately by one or more hardware and/or software components and/or layers.

Second, performance metrics 210 and/or other data may be obtained from a number of data sources. For example, data repository 134 may include data from a cloud-based data source such as a Hadoop Distributed File System (HDFS) that provides regular (e.g., hourly) updates to data associated with connections, people searches, recruiting activity, and/or profile views. Data repository 134 may also include data from an offline data source such as a Structured Query Language (SQL) database, which refreshes at a lower rate (e.g., daily) and provides data associated with profile content (e.g., profile pictures, summaries, education and work history) and/or profile completeness.

Third, the ramp-up capabilities of the system may be adapted to various types of online controlled experiments and/or hypothesis tests. For example, the system of FIG. 2 may be used to streamline and automate the ramping up of A/B tests for different features and/or versions of websites, social networks, applications, platforms, advertisements, recommendations, and/or other hardware or software components that impact user experiences. In another example, risk 216 may be compared to risk tolerance 222 using a t-test, z-test, Bayesian hypothesis testing, and/or other type of sequential or non-sequential hypothesis test.

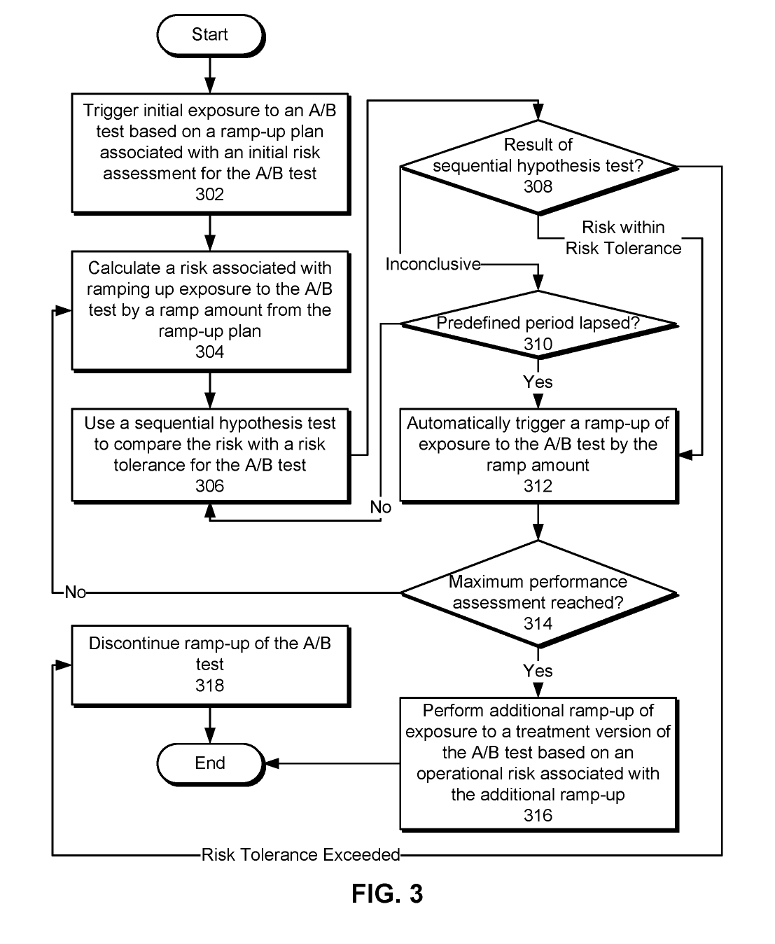

FIG. 3 shows a flowchart illustrating a process of ramping up an A/B test in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initial exposure to an A/B test is triggered based on a ramp-up plan associated with an initial risk assessment for the A/B test (operation 302). The initial risk assessment may be obtained from an experimenter associated with the A/B test. For example, the experimenter may provide the initial risk assessment as a risk category and/or risk score for the A/B test. The initial risk assessment may be matched to a ramp-up plan that specifies the initial exposure to the A/B test, as well as a series of ramp amounts for use in subsequent ramping up of the A/B test. Alternatively, the ramp-up plan may be specified by the experimenter along with and/or instead of the initial risk assessment.

Next, a risk associated with ramping up exposure to the A/B test by a ramp amount from the ramp-up plan is calculated (operation 304). For example, the ramp amount may specify an increase in the percentage of users exposed to a treatment version of the A/B test, out of all users affected by the A/B test (e.g., users who use a particular feature, application version, and/or other component or module to which the A/B test pertains). The risk may be calculated based on the ramp amount, a performance metric for the A/B test, and/or a proportion of a population affected by the A/B test (e.g., the percentage of all users of a mobile application that use a version of the mobile application affected by the A/B test).

After the risk is calculated, a sequential hypothesis test is used to compare the risk with a risk tolerance for the A/B test (operation 306). For example, the sequential hypothesis test may be a GSPRT with a null hypothesis that the risk is within the risk tolerance and an alternative hypothesis that the risk exceeds the risk tolerance. As performance metrics related to the treatment and control versions are collected, a test statistic for each hypothesis of the GSPRT is updated and compared to thresholds associated with type I and type II errors in the GSPRT to produce a result of the GSPRT.

The A/B test may or may not be ramped up based on a result of the sequential hypothesis test (operation 308). Continuing with the above example, when a test statistic for the null hypothesis exceeds a threshold representing a significance level for a type II error, the null hypothesis may be accepted, and the risk may be deemed to be within the risk tolerance. When the test statistic falls below another threshold representing a significance level for a type I error, the alternative hypothesis may be accepted, and the risk may be deemed to exceed the risk tolerance. When the test statistic is between the two thresholds, the result may be inconclusive.

When multiple performance metrics are used with the A/B test, additional risks associated with ramping up exposure to the A/B test by the ramp amount may be calculated from the performance metrics, and the sequential hypothesis test may be used to compare the additional risks with a set of additional risk tolerances for the A/B test. When the sequential hypothesis test indicates that a majority of the additional risks is within the corresponding additional risk tolerances and none of the additional risks exceed the corresponding additional risk tolerances, ramp-up of exposure to the A/B test by the ramp amount may be triggered.

When the sequential hypothesis test indicates that the risk exceeds the risk tolerance, ramp-up of the A/B test is discontinued (operation 318). For example, the A/B test may be maintained at the current level of exposure or discontinued.

When the sequential hypothesis test indicates that the risk is within the risk tolerance, a ramp-up of exposure to the A/B test is by the ramp amount is automatically triggered (operation 312). For example, a 5% ramp-up of exposure to a treatment version of the A/B test may be carried out by selecting 5% of users in a population affected by the A/B test and exposing the selected users to the treatment version. When an automatic ramp-up of the A/B test is performed, the ramp-up may be performed using the largest ramp amount that produces a risk that is still within the risk tolerance.

An inconclusive result from the sequential hypothesis test may be monitored over a predefined period (operation 310). For example, the sequential hypothesis test may be scheduled to run for up to a week. During the predefined period, data used to compare the risk with the risk tolerance is used to update the sequential hypothesis test (operation 306). If the risk exceeds the risk tolerance, ramp-up of the A/B test is discontinued (operation 318). If the risk is within the risk tolerance, automatic ramping up of the A/B test to a given ramp amount is triggered (operation 312). If the result is still inconclusive at the end of the predefined period, the risk is assumed to be within the risk tolerance, and a ramp-up of exposure to the A/B test by the ramp amount is automatically triggered (operation 312).

Operations 304-312 may be repeated to ramp up the A/B test in incremental ramp amounts specified in the ramp-up plan until a limit representing a maximum performance assessment for the A/B test is reached (operation 314). For example, ramping up of the A/B test may be conducted based on a comparison of the risk of a given ramp-up with the risk tolerance for the A/B test until 50% of all users affected by the A/B test are exposed to the treatment version.

After the limit is reached, additional ramp-up of exposure to the treatment version is performed based on an operational risk associated with the additional ramp-up (operation 316). Continuing with the previous example, ramping up of exposure to the treatment version from 50% of all affected users to 100% of all affected users may be carried out in multiple steps to ensure that infrastructure resources affected by the treatment version are able to handle additional traffic from the ramp-up.

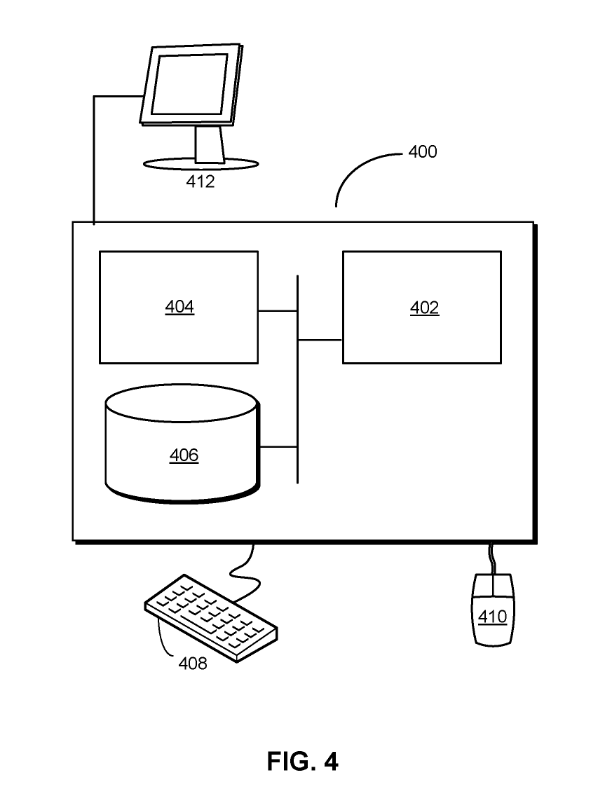

FIG. 4 shows a computer system 400 in accordance with the disclosed embodiments. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In one or more embodiments, computer system 400 provides a system for managing an A/B test. The system may include an analysis apparatus and a management apparatus, one or both of which may alternatively be termed or implemented as a module, mechanism, or other type of system component. The analysis apparatus may calculate a risk associated with ramping up exposure to an A/B test by a ramp amount. Next, the analysis apparatus may use a sequential hypothesis test to compare the risk with a risk tolerance for the A/B test. When the sequential hypothesis test indicates that the risk is within the risk tolerance, the management apparatus may automatically trigger a ramp-up of exposure to the A/B test by the ramp amount. When the sequential hypothesis test indicates that the risk exceeds the risk tolerance, the management apparatus may discontinue ramp-up of exposure to the A/B test. When the sequential hypothesis test is inconclusive at an end of a predefined period, the management apparatus may trigger a ramp-up of exposure to the A/B test by the ramp amount.

In addition, one or more components of computer system 400 may be remotely located and connected to the other components over a network. Portions of the present embodiments (e.g., analysis apparatus, management apparatus, data repository, etc.) may also be located on different nodes of a distributed system that implements the embodiments. For example, the present embodiments may be implemented using a cloud computing system that performs automatic ramp-up of exposure to a set of A/B tests for a set of remote users.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
calculating, by one or more computer systems, a first risk associated with ramping up exposure to a first A/B test by a first ramp amount;
using a first sequential hypothesis test to compare the first risk with a first risk tolerance for the first A/B test; and
when the first sequential hypothesis test indicates that the first risk is within the first risk tolerance, automatically triggering, by the one or more computer systems, a ramp-up of exposure to the first A/B test by the first ramp amount.

2. The method of claim 1, further comprising:
calculating a second risk associated with ramping up exposure to a second A/B test by a second ramp amount;
using a second sequential hypothesis test to compare the second risk with a second risk tolerance for the second A/B test; and
when the second sequential hypothesis test indicates that the second risk exceeds the second risk tolerance, discontinuing ramp-up of exposure to the second A/B test.

3. The method of claim 1, further comprising:
calculating a second risk associated with ramping up exposure to a second A/B test by a second ramp amount;
using a second sequential hypothesis test to compare the second risk with a second risk tolerance for the second A/B test; and
when comparison of the second risk with the second risk tolerance by the second sequential hypothesis test is inconclusive at an end of a predefined period, triggering a ramp-up of exposure to the second A/B test by the second ramp amount.

4. The method of claim 1, further comprising:
obtaining an initial risk assessment for the first A/B test prior to starting the first A/B test; and
triggering an initial exposure to the first A/B test based on the initial risk assessment.

5. The method of claim 4, further comprising:
obtaining the initial exposure and the first ramp amount from a ramp-up plan associated with the initial risk assessment.

6. The method of claim 4, wherein the initial risk assessment is obtained from an experimenter associated with the A/B test.

7. The method of claim 1, further comprising:
calculating a set of additional risks associated with ramping up exposure to the first A/B test by the first ramp amount;
using the first sequential hypothesis test to compare the additional risks with a set of additional risk tolerances for the first A/B test; and
when the first sequential hypothesis test indicates that a majority of the additional risks is within the corresponding additional risk tolerances and none of the additional risks exceed the corresponding additional risk tolerances, triggering the ramp-up of exposure to the first A/B test by the first ramp amount.

8. The method of claim 1, further comprising:
when the ramp-up of exposure to the first A/B test reaches a limit representing a maximum performance assessment for the A/B test, performing additional ramp-up of exposure to a treatment version of the A/B test based on an operational risk associated with the additional ramp-up.

9. The method of claim 1, wherein the first risk is calculated using:
a performance metric for the first A/B test;
a proportion of a population affected by the first A/B test; and
the first ramp amount.

10. The method of claim 1, wherein ramping up the exposure to the A/B test by the ramp amount comprises:
ramping up the exposure to the first A/B test by a largest ramp amount with a value of the risk that is within the risk tolerance.

11. The method of claim 1, wherein the first sequential hypothesis test comprises a generalized sequential probability ratio test.

12. An apparatus, comprising:
one or more processors; and
memory storing instructions that, when executed by the one or more processors, cause the apparatus to:
calculate a first risk associated with ramping up exposure to a first A/B test by a first ramp amount;
use a first sequential hypothesis test to compare the first risk with a first risk tolerance for the first A/B test; and
when the first sequential hypothesis test indicates that the first risk is within the first risk tolerance, automatically trigger a ramp-up of exposure to the first A/B test by the first ramp amount.

13. The apparatus of claim 12, wherein the memory further stores instructions that, when executed by the one or more processors, cause the apparatus to:
calculate a second risk associated with ramping up exposure to a second A/B test by a second ramp amount;
use a second sequential hypothesis test to compare the second risk with a second risk tolerance for the second A/B test; and
when the second sequential hypothesis test indicates that the second risk exceeds the second risk tolerance, discontinue ramp-up of exposure to the second A/B test.

14. The apparatus of claim 12, wherein the memory further stores instructions that, when executed by the one or more processors, cause the apparatus to:
calculate a second risk associated with ramping up exposure to a second A/B test by a second ramp amount;
use a second sequential hypothesis test to compare the second risk with a second risk tolerance for the second A/B test; and
when comparison of the second risk with the second risk tolerance by the second sequential hypothesis test is inconclusive at an end of a predefined period, trigger a ramp-up of exposure to the second A/B test by the second ramp amount.

15. The apparatus of claim 12, wherein the memory further stores instructions that, when executed by the one or more processors, cause the apparatus to:
obtain an initial risk assessment for the first A/B test prior to starting the first A/B test;
obtain an initial exposure to the first A/B test and the first ramp amount from a ramp-up plan associated with the initial risk assessment; and
trigger an initial exposure to the first A/B test.

16. The apparatus of claim 12, wherein the memory further stores instructions that, when executed by the one or more processors, cause the apparatus to:
calculate a set of additional risks associated with ramping up exposure to the first A/B test by the first ramp amount;
use the first sequential hypothesis test to compare the additional risks with a set of additional risk tolerances for the first A/B test; and
when the first sequential hypothesis test indicates that a majority of the additional risks is within the corresponding additional risk tolerances and none of the additional risks exceed the corresponding additional risk tolerances, trigger the ramp-up of exposure to the first A/B test by the first ramp amount.

17. The apparatus of claim 12, wherein the memory further stores instructions that, when executed by the one or more processors, cause the apparatus to:
when the ramp-up of exposure to the first A/B test reaches a limit representing a maximum performance assessment for the A/B test, perform additional ramp-up of exposure to a treatment version of the A/B test based on an operational risk associated with the additional ramp-up.

18. The apparatus of claim 12, wherein the first risk is calculated using:
a performance metric for the first A/B test;
a proportion of a population affected by the first A/B test; and
the first ramp amount.

19. The apparatus of claim 12, wherein ramping up the exposure to the A/B test by the ramp amount comprises:
ramping up the exposure to the first A/B test by a largest ramp amount with a value of the risk that is within the risk tolerance.

20. A non-transitory computer-readable storage medium storing instructions that when executed by a computer cause the computer to perform a method, the method comprising:
calculating a first risk associated with ramping up exposure to a first A/B test by a first ramp amount;
using a first sequential hypothesis test to compare the first risk with a first risk tolerance for the first A/B test; and
when the first sequential hypothesis test indicates that the first risk is within the first risk tolerance, automatically triggering a ramp-up of exposure to the first A/B test by the first ramp amount.
